(19) United States
(12) Patent Application Publication
(10) Pub. No.: US 2026/0281662 A1
(43) Pub. Date: Sep. 17, 2026

(54) METHODS AND APPARATUSES FOR CONTROLLING A PATH TAKEN BY A FIRST WIRELESS DEVICE

(71) Applicant: Telefonaktiebolaget LM Ericsson (publ), Stockholm (SE)

(72) Inventors: Ursula CHALLITA, Solna (SE); Kimmo HILTUNEN, Esbo (FI)

(73) Assignee: Telefonaktiebolaget LM Ericsson (publ), Stockholm (SE)

(21) Appl. No.: 19/167,923

(22) PCT Filed: Mar. 24, 2023
(86) PCT No.: PCT/EP2023/057698

§ 371 Date: Sep. 23, 2025

(51) Int. Cl. H04W 4/024; H04B 17/373; H04W 28/24

(52) U.S. Cl. CPC H04W 4/024; H04B 17/373; H04W 28/24

(57) ABSTRACT

Embodiments described herein relate to methods and apparatuses for controlling a path of a first wireless device, wherein the first wireless device is in communication with a first radio network using at least a first spectrum band. A computer implemented method comprises obtaining a model of a geographical environment and a radio environment through which the first wireless device is travelling, wherein the radio environment comprises a second radio network using at least the first spectrum band; predicting whether a quality-of-service, QoS, requirement for the first wireless device is met if the first wireless device takes an initial path through the geographical environment for a first time period; predicting whether an interference level meets a first condition if the first wireless device takes the initial path for the first time period, wherein the interference level is caused by communication between the first wireless device and the first radio network on the second radio network; and responsive to predicting that either the QoS requirement will not be met during the first time period, or the interference level will not meet the first condition during the first time period, initiating an update to the initial path to provide a new path to be taken by the first wireless device.

### TECHNICAL FIELD

Embodiments described herein relate to methods and apparatuses for controlling a path taken by a first wireless device. In particular, the methods and apparatuses described herein control the path of the first wireless device to ensure that an interference level caused by communication between the first wireless device and a first radio network on a second radio network meets a first condition.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The fifth generation (5G) of the mobile networks is envisioned to feature different service classes, for example, ultra-reliable low-latency communications (URLLC), massive machine type communications (mMTC), and enhanced mobile broadband (eMBB). While eMBB aims at high spectral efficiency, hard latency (e.g., 1 ms) and reliability requirements (target block error rate (BLER) between 10⁻⁵ and 10⁻⁹) are essential for URLLC applications. In essence, the stringent latency and reliability requirements of URLLC enable new emerging use cases such as factory automation, drone communication, remote control, and remote surgery.

One important use case for URLLC is the support of automated guided vehicles (AGV), unmanned aerial vehicles (UAV) and self-driving cars. These kinds of devices are designed to automatically travel along predefined routes and they are wirelessly connected (e.g., via a high-quality and low-latency 5G New Radio (NR) radio link) to a public or non-public network which is responsible for controlling the devices.

Since these devices are moving, the quality of the radio link will be constantly changing. To compensate for this and to maintain the required quality-of-service (QoS), the responsible network and the AGV will typically apply various kinds of reactive radio resource management (RRM) actions, acting on various kinds of link quality measurements (for example, on the reference signal received power (RSRP), channel quality indicator (CQI) and channel state information (CSI). These RRM actions may for example comprise one of: handover, link adaptation, power control, scheduling and beam management. Such reactive RRM actions may be able to maintain a sufficient QoS in most cases. However, they will not always be able to satisfy the high reliability requirements of URLLC services, including, for example, the required high-quality radio link between a network and an AGV.

The 5G NR network will have to co-exist both with other cellular networks (for example private networks), operating either on the same or adjacent frequency channels, and potentially with incumbent users of the same spectrum band (including for example satellite systems, fixed communication links or radars).

In order to keep the level of the interference between the networks at a sufficiently low level, the 5G NR network can take the neighboring networks into account during the network deployment phase (for example when planning the locations of the base station sites, transmitted power levels or the orientations of the antennas), and/or with the help of various actions to coordinate the use of radio resources.

However, the actions available to the 5G NR network are typically static or semi-static, even though the level and the impact of the inter-network interference can be highly dynamic. This can then lead to an inefficient use of the radio resources or some occasional interference peaks. The occasional interference peaks will typically result in lost packets, which in the case of eMBB and other best-effort or non-latency-critical services can easily be compensated with the help of packet retransmissions. However, in the case of latency-critical URLLC services, the latency budget may not always allow for any retransmissions and the lost packet may in the worst case result in radio link failure.

In the future, it may be possible to apply proactive RRM actions with the help of artificial interference (AI) and machine learning (ML), as described in (PCT/SE2019/051124 and PCT/SE2021/050492). In the proposed schemes, the network will predict the future QoS of the radio link with the help of AI/ML and apply necessary RRM actions already before the link quality becomes too low. In this way, the probability of any radio link failures can be reduced, and the desired QoS can be guaranteed, while at the same time utilizing the radio resources in a more efficient way.

### SUMMARY

The problem with the traditional reactive RRM methods is that they are not able to compensate for sudden drops in radio link quality, resulting in radio link failures, in particular, in the case of URLLC services that require a very high and guaranteed QoS. In other scenarios, the reactive RRM methods may lead to an inefficient use of the radio resources if the system has to apply a high level of redundancy or large margins to be able to cope with the sudden changes in the radio link quality.

Another limitation of reactive RRM methods is that they do not in any way utilize the fact that the network is able to control the movement of the device.

Embodiments described herein therefore enable the 5G NR network to have the possibility of controlling for example the movement of an AGV, reduce the level and in particular the impact of the inter-network radio interference while also guaranteeing that the operation/mission of the AGV is fulfilled. In practice, this may mean that the 5G NR network will select a different route for the AGV, in which a sufficiently large distance is left between the AGV and a) the source of interference to protect the radio link between the network and the AGV, or b) the victim that should be protected from the interference caused by the AGV or the controlling network. Embodiments described herein may therefore provide route re-design to guarantee the required service level so as to maximize the radio network performance whilst a) not jeopardizing the mission/task of the AGV (for instance, the time needed to complete its mission or reach its destination) and b) minimizing the level of any harmful interference towards other users of the same spectrum band.

According to some embodiments there is provided a computer implemented method for controlling a path taken by a first wireless device, wherein the first wireless device is in communication with a first radio network using at least a first spectrum band. The method comprises obtaining a model of a geographical environment and a radio environment through which the first wireless device is travelling, wherein the radio environment comprises a second radio network using at least the first spectrum band; predicting whether a quality-of-service, QoS, requirement for the first wireless device is met if the first wireless device takes an initial path through the geographical environment for a first time period; predicting whether an interference level meets a first condition if the first wireless device takes the initial path for the first time period, wherein the interference level is caused by communication between the first wireless device and the first radio network on the second radio network; and responsive to predicting that either the QoS requirement will not be met during the first time period, or the interference level will not meet the first condition during the first time period, initiating an update to the initial path to provide a new path to be taken by the first wireless device.

According to some embodiments there is provided an apparatus for controlling a path taken by a first wireless device, wherein the first wireless device is in communication with a first radio network using at least a first spectrum band. The apparatus comprises processing circuitry configured to cause the apparatus to obtain a model of a geographical environment and a radio environment through which the first wireless device is travelling, wherein the radio environment comprises a second radio network using at least the first spectrum band; predict whether a quality-of-service, QoS, requirement for the first wireless device is met if the first wireless device takes an initial path through the geographical environment for a first time period; predict whether an interference level meets a first condition if the first wireless device takes the initial path for the first time period, wherein the interference level is caused by communication between the first wireless device and the first radio network on the second radio network; and responsive to predicting that either the QoS requirement will not be met during the first time period, or the interference level will not meet the first condition during the first time period, initiate an update to the initial path to provide a new path to be taken by the first wireless device.

According to some embodiments there is provided a computer program comprising instructions which, when executed on at least one processor, cause the at least one processor to carry out a method as described herein.

According to some embodiments there is provided a computer program product comprising non transitory computer readable media having stored thereon a computer program as described above.

For the purposes of the present disclosure, the term “ML model” encompasses within its scope the following concepts:
Machine Learning processes (or algorithms), for example comprising instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task.

References to “ML model”, “model”, model parameters”, “model information”, etc., may thus be understood as relating to any one or more of the above concepts encompassed within the scope of “ML model”.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a computer implemented method for controlling a path taken by a first wireless device to reach a desired destination/to enable a task to be completed by the first wireless device by a given time;

FIG. 2 is a flowchart illustrating an example implementation of the method of FIG. 1.

FIG. 3 is a signalling diagram illustrating an example implementation of the methods of FIGS. 1 and 2;

FIG. 4 is a diagram of a network digital twin whereby the actions of the third ML model are first tested on the network digital twin before being transferred to real deployments;

FIG. 5 illustrates an example scenario in which the methods of FIGS. 1 and 2 are implemented;

FIG. 6 illustrates an apparatus comprising processing circuitry (or logic);

FIG. 7 is a block diagram illustrating an apparatus according to some embodiments.

### DESCRIPTION

Certain aspects of the present disclosure and their embodiments may provide solutions, or at least mitigate, challenges discussed herein. The steps of any methods disclosed herein do not have to be performed in the exact order disclosed, unless a step is explicitly described as following or preceding another step and/or where it is implicit that a step must follow or precede another step.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The problems mentioned above may be improved by implementing proactive RRM mechanisms, as we have proposed in PCT/SE2019/051124 and PCT/SE2021/050492. For example, PCT/SE2019/051124 proposes a method for scheduling enhanced mobile-broadband, enhanced mobile broadband (eMBB), transmissions, wherein the eMBB is on the same frequency as an ultra-reliable low latency communication network, URLLC, the method comprising: predicting a time division duplex, TDD, pattern for the URLLC based on historical URLLC TDD data; and scheduling an eMBB TDD pattern, based on the predicted URLLC TDD pattern, so as to manage cross-link interference on the URLLC network.

PCT/SE2021/050492 proposes a location-aware radio resource management scheme for protecting the URLLC network from eMBB uplink transmissions when an eMBB user is inside the factory. In the proposed scheme, the URLLC network first detects whether there is an eMBB user inside the factory or nearby that is causing high interference level on the URLLC network. If an eMBB user is detected to be inside the factory, the URLLC network localizes this user and predicts its future trajectory. The URLLC network can then take several actions to minimize the impact of the high interference from uplink transmissions of eMBB users(s) inside the factory such as increasing operating power.

Even though the proposed proactive RRM mechanisms in PCT/SE2019/051124 and PCT/SE2021/050492 can improve the QoS, such methods will not always be sufficient, or they could potentially even jeopardize the QoS of the radio link between the AGV and the network when for example aiming to limit the level of the inter-network interference.

Embodiments described herein provide a QoS-aware method for initiating rerouting of a path of a first wireless device (e.g. an AGV) that is being controlled by a public or non-public cellular network.

In particular, the path of a first wireless device may be updated such that a tradeoff between maximizing energy efficiency of the first wireless device, minimizing network congestion, and meeting QoS requirements of both the first wireless device and any second radio network utilizing the same spectrum band. The second radio network may comprise one or more of a cellular network, a satellite system, a fixed communication link or a radar network.

Some embodiments further combine both the proactively re-designing the path taken by first wireless device with actions to proactively adjust the RRM settings to guarantee both the required service level of the first wireless device and the required level of protection for the second radio network.

In implementation of the embodiments described herein four ML models may be used. It will be appreciated that in some examples a single ML Model may be utilized to perform the functions of two or more of the four ML models described.

A first ML model may be used to predict whether or not the QoS requirements for the first wireless device is met along if the first wireless device takes an initial path through the geographical environment for a first time period (e.g. a next k subframes of the communication between the first wireless device and a first radio network). A second ML model may be used to predict whether or not an interference level meets a first condition if the first wireless device takes the initial path for the first time period, wherein the interference level is caused by communication between the first wireless device and the first radio network on the second radio network. Herein the term “interference level” may be used to refer to the interference caused by the communication between the first wireless device and the first radio network on the second radio network.

In some embodiments a third ML model may be used to determine a new path for the first wireless device for the first time period. The third ML model may re-design the route (or path) for the first wireless device, and, in some examples, may also recommend one or more RRM actions to be taken during the first time period, to guarantee the QoS of the first wireless device whilst minimizing the interference level.

For example, the third ML model may learn an optimal route for the first wireless device and, optionally, learn whether additional RRM actions will be needed to guarantee/maximize the QoS of the first wireless device, (in case the QoS of the AGV cannot be met along its current chosen route) while protecting the victim network and minimizing the interference level caused by the first wireless device and the first radio network on the second radio network that may be conducting critical activities.

In some examples, a fourth ML model may be used to predict the loads on one or more cells within the first radio network. This prediction may be used as an input to one or more of the first ML model, the second ML model and the third ML model.

In some examples, embodiments described herein may then comprise informing the first wireless device of the new route and, if applicable, the one or more RRM actions for the first wireless device to take during the first time period.

In some examples, the first wireless device may then update its route based on the received new path and it may perform any indicated RRM actions.

It will be appreciated that some embodiments described herein are therefore able to proactively re-plan the route taken by the first wireless device with the help of one or more ML models, so that the QoS requirements of the high-quality radio link between the first wireless device and the first radio network may be guaranteed, and any harmful interference caused by the first wireless device and the first radio network controlling the first wireless device towards the second radio network can be avoided or reduced.

In some embodiments, the expected fulfilment of the QoS requirement for the first wireless device and the interference level are continuously monitored, and proactive actions may be taken to re-route the first wireless device as well as potentially making additional RRM actions in case the predicted QoS of the first wireless device on the new path does not fulfill a QoS requirement or the predicted interference level when the first wireless device is on the new path does not meet the first condition.

The additional proactive RRM actions may comprise one or more of: handover (between different serving base stations, different frequencies or different radio access technologies), link adaptation, power control, beam management and coordinated scheduling. The additional proactive RRM actions may be beneficial in scenarios where alternative routes do not exist, or when the alternative routes would not be able to guarantee the desired service level for the first wireless device (e.g., the alternative routes would be too long so that the first wireless device would not reach a destination in time) or the alternative routes would not be able to guarantee a sufficiently low interference level.

It will be appreciated that the new path may be learned and selected with the help of artificial intelligence or machine learning, for example, based on some pre-defined optimization criteria, including for example: the overall system capacity, the QoS requirement of the first wireless device, the interference level, a travel time of the first wireless device, and energy consumption of the first wireless device.

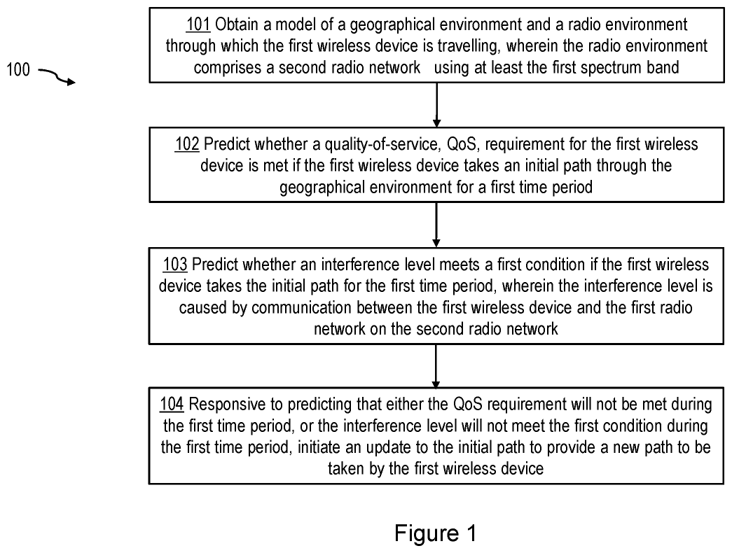

FIG. 1 illustrates a computer implemented method for controlling a path taken by a first wireless device to reach a desired destination/to enable a task to be completed by the first wireless device by a given time. The first wireless device is in communication with a first radio network using at least a first spectrum band. The first wireless device may comprise an automated guided vehicle AGVs, but it should be understood that the proposed idea will be valid for the control of any network-controlled devices with similar characteristics (e.g., UAVs and self-driving cars) as well. It will be appreciated that the method may be applied for a plurality of first wireless devices. Furthermore, methods of the present disclosure are not limited to non-public industrial deployments alone, but it can also be applied to any communication networks which are controlling the mobility of wirelessly connected devices.

The method 100 may be performed by a network node, which may comprise a physical or virtual node, and may be implemented in a computing device or server apparatus and/or in a virtualized environment, for example in a cloud, edge cloud or fog deployment. The network node may comprise a network node in the first radio network node, for example a base station.

In step 101 the method comprises obtaining a model of a geographical environment and a radio environment through which the first wireless device is travelling, wherein the radio environment comprises a second radio network using at least the first spectrum band. It will be appreciated that the second radio network may comprise a cellular network, a satellite system, a fixed communication link or a radar system. Information in the model may be used as an input to steps 102 and 103 as will be described below.

It will be appreciated that step 101 may comprise generating the model. The model may be generated based on information received from network nodes and/or wireless devices in the first radio network and or second radio network. The model may also be generated based on a digital map of the geographical area.

A user of the second radio network may therefore comprise a node (e.g. a wireless device or a base station) within a neighboring (public or private) cellular network, a satellite receiver (gateway station, satellite or a satellite terminal), or a fixed communication link or a radar. Any of these users may be victims of the interference level caused by the communication between the first wireless device and the first radio network.

The model comprises information about the radio environment which comprises at least the first radio network and the second radio network using at least the first spectrum band. It will be appreciated that there may be more than one second radio network (which may be referred to as a victim network) operating on the same spectrum band (e.g. at least the first spectrum band) as the first radio network within the radio environment. The model may be considered to comprise a virtual data model of the geographical environment and the radio environment.

It will also be appreciated that the model may comprise two types of information: static information and dynamic information. During operation, the contents of the model may be continuously updated and refined based on the measurements received from network nodes, base stations and wireless devices in the first radio network and the second radio network, as well as on measurements performed by additional sensors deployed around the geographical area.

The static information may comprise, for example, a digital map of the geographical area in question, information about allowed paths (roads, corridors, etc) that the first wireless device can take, and locations of static radio network nodes (for example, base stations). The static information may also comprise information relating to the second radio network, e.g., locations of the static radio network nodes of the second radio network (base stations, fixed communication links, satellite gateway stations, fixed satellite terminals, radars). The static information is expected to be fairly stable and does not need to be updated that often.

The model may also define a threshold for maximum allowed QoS degradation of the victim network. This may be defined as part of the static information or the dynamic information.

In addition to the static information, the model may comprise dynamic information about the current state of the radio environment, including for example information about the locations of the mobile terminals, the cell load, the user performance, and the resource blocks on which the users are scheduled. Information about the current radio environment may comprise information relating to the first radio network and, optionally, the second radio network depending on how a threshold for the maximum allowed QoS degradation for the first wireless device has been defined, and if potential interference from the second radio network towards the first radio network should be taken into account when evaluating the QoS of the first wireless device.

The dynamic information may also comprise input from external sources, such as information received from the second radio network or a spectrum sharing database, which may assist in setting an appropriate dynamical threshold for a maximum allowed QoS degradation of at the second radio network and to provide feedback on the interference level. The contents of the dynamic information may be updated much more often compared to the static information. Furthermore, the first radio network may be required to keep track of the history of the dynamic information to assist the AI/ML functionality.

Step 102 comprises predicting whether a quality-of-service, QoS, requirement for the first wireless device is met if the first wireless device takes an initial path through the geographical environment for a first time period. The first time period may comprise a next k subframes in the communication between the first wireless device and the first radio network. A QoS may be defined in terms of latency and block error rate, BLER, or as the availability of the desired service, (see for example 5G-SMART, “5G Common Terminology”, 2020. https://5gsmart.eu/wp-content/uploads/5G-SMART-common-terminology.pdf, 3GPP, “Quality of Service (QoS) concept and architecture (Release 17)”, 3GPP TS 23.107, V17.0.0, 2022, 3GPP, “Service requirements for cyber-physical control applications in vertical domains (Release 18)”, 3GPP TS 22.104, V18.3.0, 2021, and 3GPP, “Service requirements for the 5G system (Release 19)”, 3GPP TS 22.261, V19.0.0, 2022)

It will be appreciated that the QoS requirement may comprise a requirement that a QoS metric experienced by the first wireless device meets a QoS threshold. The QoS threshold may comprise a static threshold or a dynamic threshold.

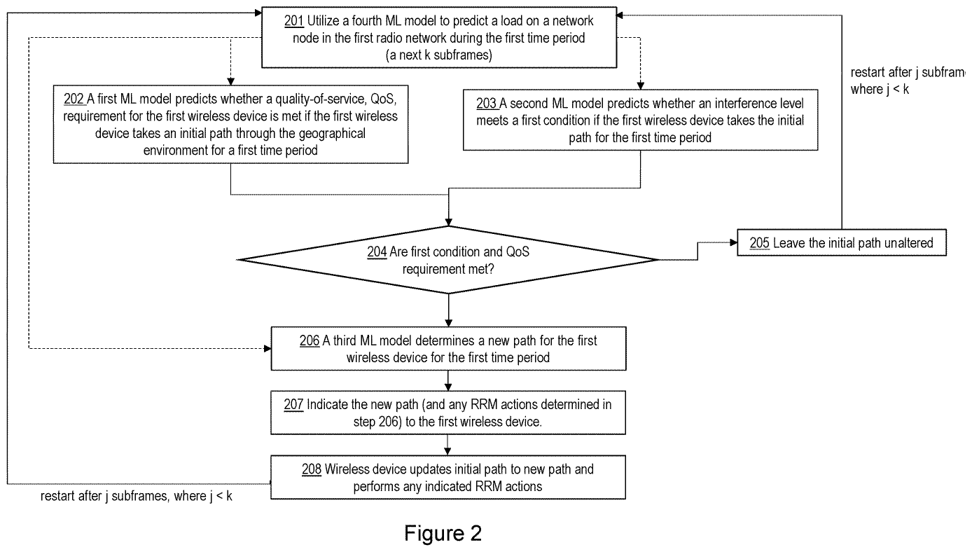

Step 102 may comprise utilizing a first ML Model to predict whether the QoS requirements are met for the first time period, for example as described in more detail with reference to FIG. 2. Step 102 may utilize the information in the model obtained in step 101 in order to predict whether the QoS requirements are met for the first time period.

Step 103 comprises predicting whether an interference level meets a first condition if the first wireless device takes the initial path for the first time period, wherein the interference level is caused by communication between the first wireless device and the first radio network on the second radio network.

Step 103 may comprise utilizing a second ML model to predict whether the first condition is met, for example, as described in more detail with reference to FIG. 2. Step 103 may utilize the information in the model obtained in step 101 in order to predict whether the QoS requirements are met for the first time period.

The first condition may comprise a configuration that the interference level is less than an interference threshold value. The interference threshold value may be static or dynamic.

The interference threshold value may for example be expressed as one of: a maximum allowed transmission power towards the second radio network, a maximum allowed received interference power (I) measured at the second radio network, and a maximum allowed interference power over noise (I/N) measured at the second radio network. In these examples, the model may not comprise dynamic information about the second radio network other than the dynamic interference threshold value, if applicable.

In other examples, the interference threshold value may be expressed for example as a reduction of link quality (SINR, or CIR) or a reduction of a user performance (bit rates, throughput). In these examples, the model may be required to comprise additional dynamic information about the second radio network as described above.

In the case of a dynamic interference threshold value, the interference threshold value may depend on activity, spatial characteristics (antenna beam directions) and the resource needs (e.g., which resource blocks or frequency sub-bands the second radio network would be occupying during the first time period) of the second radio network.

The dynamic interference threshold value may typically be provided or signaled to the first radio network, either directly by the second radio network or by a special spectrum sharing database.

In practice, the first radio network may transmit a “spectrum access request” message to the spectrum sharing database or directly to the second radio network that has the primary right to use the spectrum). The spectrum access request message may indicate an amount of spectrum that is requested and the geographical location where the spectrum will be used. As a response, the spectrum sharing database or the second radio network may transmit a “spectrum access grant” message, indicating which particular frequency channels would be available for sharing, the corresponding dynamic interference threshold value and how long the spectrum access grant would be valid (e.g., the next x seconds, where x is an integer value). After receiving the “spectrum access grant” message, the first radio network may then decide which frequency channels it will reuse and may use the dynamic interference threshold value as an input when performing step 103 (and 104).

An indication or feedback on the interference level may be important for scenarios where the first radio network is not able to retrieve detailed information regarding the state of the second radio network. Furthermore, it may be important for scenarios where the second radio network is an incumbent user of the first spectrum band. Feedback of the interference level may be provided either directly by the second radio network or by a special spectrum sharing database or by various sensors deployed around the geographical area, for example in close proximity to the second radio network.

The feedback may be provided as either a binary indication (e.g. indicating whether the interference level is below the interference threshold value or not) or a measurement value indicating the actual interference level or the impact of the interference level. If the second radio network is a private/public cellular network the measurement value may, for example, indicate the interference level (I or I/N) and/or the impact of the interference level on the QoS provided to one or more users of the second radio network. Furthermore, if the second radio network comprises an incumbent user of the first spectrum band, the measurement value may indicate the interference level (I or I/N).

Step 104 comprises, responsive to predicting that either the QoS requirement will not be met during the first time period, or the interference level will not meet the first condition during the first time period, initiating an update to the initial path to provide a new path to be taken by the first wireless device.

In some examples, the first radio network may have access to a digital twin (DT) of the model of the radio environment and the geographical area, which may also comprise information about the propagation of data between the network nodes and the radio networks themselves, in addition to the static and/or dynamic information described above. In these examples, the paths and the potential RRM actions to guarantee both the desired QoS for the first wireless device and the sufficiently low level of interference towards the second radio network may be optimized with the help of simulations in the DT.

However, in practice such simulations may require quite complex calculations, an accurate model of the propagation environment and frequently updated dynamic information. If the optimization/prediction is based on AI/ML methods instead, as proposed herein (and described in more detail with reference to FIG. 2), the network may only need access to selected parts of the full network digital twin, for example there would not be a need to maintain a model for the propagation environment.

Moreover, the high complexity of the action space (large number of possible paths and RRM actions) and the need for an online action update makes the use of ML more suitable to the underlying problem.

FIG. 2 is a flowchart illustrating an example implementation of the method of FIG. 1.

In step 201 the method comprises utilizing a fourth ML model to predict a load on a network node in the first radio network during the first time period. In particular, the fourth ML model may predict the loads of the network nodes within the environment. The network node may comprise a first network node that is serving the first wireless device in the first radio network. In some examples, the network node may comprise a neighboring network node to the first network node in the first radio network. It will be appreciated that the fourth ML model may predict the load on a plurality of network nodes in the first radio network.

Cell load (e.g. the load on the network node) may be considered one of the most important pieces of the dynamic information in the model as it may affect the QoS of the first wireless device in multiple ways.

For example, a high load in a neighboring network node (or a neighboring cell) (from the private or public 5G NR networks) may imply a high level of interference, and hence a potentially low level of the received signal-to-interference-plus-noise ratio (SINR) for the first wireless device, resulting in a low data rate or data throughput.

In another example, a high load in the first network node may imply that an individual user can only occupy a small share of the radio resources, resulting in a reduced data throughput and/or latency for that user.

A high load may be caused by multiple factors, for example a number of users of the network node, characteristics the requested services (packet arrival rates, packet sizes, service priorities) and the level of the external interference. In all, information about the load of the different network nodes in the first radio network, together with selected contents of the model, can be used to calculate or predict the achievable QoS (e.g., in terms of data throughput, reliability (BER/BLER) and latency) for the first time period (e, g, the next k subframes), for both an initial path for the first wireless device and a new path for the first wireless device.

In some examples, the fourth ML model may comprise one or more of: a random forest and neural network.

For the fourth ML model to predict a load at the network node during the first time period, the fourth ML model may receive one or more of the following parameters as an input:
one or more historical load levels of wireless devices connected to the network node;
one or more characteristics of the service requested such as;
   one or more historical packet arrival rates for one or more wireless devices connected to the network node;
   one or more historical packet sizes received or transmitted by one or more wireless devices connected to the network node;
   one or more historical service priorities of one or more wireless devices connected to the network node;
a historical number of wireless devices that are connected, active or scheduled at the network node;
a historical number of RRC connections at the network node;
one or more historical values of a level of external interference experienced at the network node;
a current number of wireless devices connected to the network node;
one or more historical values of velocities of one or more wireless devices connected to the network node;
the paths of one or more wireless devices currently connected to the network node, e.g. a set of future locations (coordinates) of the one or more wireless devices for a next k subframes; and
packet sizes for one or more wireless devices currently connected to the network node for a next k subframes.

It will be appreciated that herein historical values may comprise values taken over a previous m (where m is an integer value) subframes in the communication of the first wireless device with the first radio network.

The output of the fourth ML model may comprise a predicted load for at least one network node, Network node XX, in the first radio network at a particular time stamp, time TT. This information relating to the predicted load for at least one network node may be used as an input to the first ML model, the second ML model, or the third ML model (as will be described later with reference to steps 202, 203 and 206). In other words, the predicted load may be used to perform one or more of the steps of: predicting whether the QoS, requirement for the first wireless device is met if the first wireless device takes the initial path for the first time period; and predicting whether the interference level meets the first condition if the first wireless device takes the initial path for the first time period. The predicted load may also be used to determine a new path for the first wireless device for the first time period.

The fourth ML model may be deployed either on the cloud or on each base station/node separately. To minimize the cost of transferring data to the cloud and, in particular, if all input features are available locally at each network node, the fourth ML model may be deployed at each network node locally and may be re-trained periodically (every X hours or Y days) using local data received from the one or more wireless devices connected to that particular network node.

In step 202, a first ML model predicts whether a quality-of-service, QoS, requirement for the first wireless device is met if the first wireless device takes an initial path through the geographical environment for a first time period. Step 202 comprises an example implementation of step 102 of FIG. 1. The first time period may comprise a next k subframes in the communication between the first wireless device and the first radio network.

The first ML model may in some examples be deployed in the cloud. The first ML model may predict whether or not the QoS requirement for the first wireless device can be met for the next possible locations along its initial path for the upcoming k subframes.

The value of k may be chosen depending on a time required for the first wireless device to update its path and/or take additional RRM actions (as will described more later) to guarantee its QoS and/or minimize the interference the first wireless device and the first radio network are causing on the second radio network.

It will be appreciated that there may be a tradeoff between prediction accuracy and proactive action decision in the selection of the value of k, for example, for a larger value of k, the prediction accuracy decreases but the first wireless device has more time to update its path and/or perform RRM actions.

The first ML model may comprise an ML model realized using supervised learning techniques, for example a neural network, a random forest, a logistic regression, a gradient boosting tree, and a Long Short-Term Memory (LSTM) model. The first ML model may predict over each of the next k subframes, if the QoS requirement is met.

Therefore, the prediction of the first ML model may be a binary classification problem over a set of future time stamps (t=0, t=1, t=1, . . . t=k). In other words, the first ML model may predict for each subframe in the next k subframes if the QoS requirement is met.

The first ML model may receive, but is not limited to receiving, any one or more of the following example inputs:

### Network Features

A historical interference level experienced by the wireless device. For example, an interference level experienced by: the first wireless device in a downlink direction, and the first network node in the uplink direction;
One or more historical values of an averaged downlink and uplink throughput of the first network node;
One or more historical values of the averaged downlink and uplink throughput of one or more neighbouring network nodes in the first radio network to the first network node;
One or more historical values of a number of active and/or scheduled wireless devices at the first network node;
One or more historical values of a number of active and/or scheduled users at neighbouring network nodes to the first network node in the first radio network;
One or more historical values of load on the first network node
One or more historical values load on one or more neighbouring network nodes to the first network node
One or more historical values of the utilized frequency domain resources utilised by the first network node;
A predicted load at a neighbouring network node XX (which may be provided as an output at step 201).
A location of one or more static network nodes of the first radio network within the geographic environments;
A location of temporarily and/or permanent obstacles/devices within the geographic environments;

### Optional Input—When the Second Radio Network Comprises a Public/Private Cellular Network

A predicted load at one or more neighbouring network nodes belonging to the second radio network;
One or more historical values of a number of active and/or scheduled wireless devices at network nodes belonging to the second radio network;
One or more historical values of load at one or more network nodes belonging to the second radio network;
One or more historical values of utilized frequency domain resources at the one or more network nodes belonging to the second radio network;
Locations of one or more static network node belonging to the second radio network.

### Optional Input—If the Second Radio Network Comprises One or More Incumbent Users of the First Spectrum Band

Locations of one or more static nodes of the second radio network;
Locations of one or more wireless devices of the second radio network;
One or more historical values of utilized frequency domain resources utilised by the second radio network;
Information regarding planned availability of the first spectrum band for the next k subframes (e.g., “spectrum access grants”);

### First Wireless Device Features

A Serving cell-id associated with the first network node;
One or more historical values for relating to a channel quality indicator (CQI) and/or a Signal-to-interference-and noise ratio experienced by the first wireless device;
one or more historical values of a RSRP, RSSI, and/or RSRQ measured by the first wire less device;
One or more historical values of an achievable latency for the first wireless device;
One or more historical values of a bit error rate or a block error rate achieved by the first wireless device;
A speed of the first wireless device (it will be appreciated that URLLC devices within a factory would typically move at a relatively slow speed);
An initial path of the first wireless device, e.g. a set of future locations (coordinates) of the first wireless device for a first time period (e.g. a next k subframes).
A packet size transmitted to or received from the first radio network for the next k subframes;
One or more historical values for a packet arrival rate at the first wireless device;
One or more historical values for a service priority associated with a service provided to the first wireless device;
One or more historical values for the location of the first wireless device;
The QoS requirement of the first wireless device, which may comprise a latency requirement, a reliability requirement and/or a throughput requirement;
One or more locations of X neighboring wireless devices and their corresponding activity level/service characteristics (e.g. packet arrival rate, service priority, packet size).

In some examples, the first ML model may receive one or more of the following inputs:
a historical interference level experienced by the first wireless device;
one or more historical values of traffic load on a network node serving the first wireless device and/or one or more neighbouring network nodes in the first radio network;
one or more historical values of latency experienced by the first wireless device;
one or more historical values of a bit error rate or a block error rate experienced by the first wireless device;
one or more historical values of a packet arrival rate experienced by the first wireless device;
the QoS requirement of the first wireless device; and
a predicted load at one or more neighbouring network nodes to the network node serving the first wireless device.

In some examples, the output of the first ML model comprises a vector of binary values that indicate whether or not the QoS requirement of the first wireless device is predicted to be met, over each of the next k subframes.

In some other examples, the first ML model predicts for each subframe in the next k subframes values of one or more QoS metrics associated with the communication between the first wireless device and the first radio network. In other words, the first ML model may learn the value of the future achievable delay/latency, reliability (BER/BLER), and/or throughput given the current state of the network, and for the future locations of the first wireless device for the next k subframes.

This actual values of the QoS metrics may be critical for some industrial applications where for instance, a connected screwdriver requires a stable latency value over a certain period of time (in other words, peaks are undesirable). So the actual values of the QoS metrics may be useful for some applications, whilst a prediction of whether or not the QoS requirement is met in each subframe is sufficient for other applications.

In these examples, the output of the first ML model may comprise a vector of predicted QoS metrics for the first wireless device, over each of the next k subframes.

For instance, in case of predicting the throughput value, the first ML model may receive one or more of the following features (Network features, Features if the second radio network is a public/private cellular network, Features if the second radio network is an incumbent user of the first spectrum band, First Wireless device Features):

### Network Features

one or more historical values of the load on the first network node;
a predicted load at one or more neighbouring network nodes (which may be provided as the output of step 201)
a location of temporarily and permanent obstacles and/or devices within the geographical area;
one or more locations of one or more static network nodes within the geographical area.

### Optional Input—Features If the Second Radio Network Is a Public/Private Cellular Network

A predicted load at one or more neighbouring network nodes in the second radio network (where the neighbouring network nodes are close to the first network node in the first radio network);
One or more historical values of the number of active and/or scheduled wireless devices at the neighbouring network nodes of the second radio network;
One or more historical values of the load on neighbouring network nodes in the second radio network;
One or more historical values of utilized frequency domain resources at the neighbouring network nodes belonging to the second radio network;
One or more locations of the static network nodes belonging to the second radio network;

### Optional Input—Features If the Second Radio Network Is an Incumbent User of the First Spectrum Band

One or more locations of the static network nodes of the second radio network
One or more historical values of the utilized frequency domain resources at the neighbouring network nodes belonging to the second radio network;
Information about the availability of the first spectrum band for the next k subframes

### First Wireless Device Features

One or more historical values of a channel state vector for the first wireless device;
One or more historical values of an averaged downlink and uplink throughput of the first wireless device;
One or more historical values for relating to a channel quality indicator (CQI) and/or a Signal-to-interference-and noise ratio experienced by the first wireless device;
one or more historical values of a RSRP, RSSI, and/or RSRQ measured by the first wireless device;
A speed of the first wireless device (it will be appreciated that URLLC devices within a factory would typically move at a relatively slow speed);
An initial path of the first wireless device, e.g. a set of future locations (coordinates) of the first wireless device for a first time period (e.g. a next k subframes).
A packet size transmitted to or received from the first radio network for the next k subframes;
One or more historical values for a packet arrival rate at the first wireless device;
One or more historical values for the location of the first wireless device;
One or more locations of X neighbouring wireless devices and their corresponding activity level/service characteristics (e.g. packet arrival rate, service priority, packet size).

In step 203 a second ML model predicts whether an interference level meets a first condition if the first wireless device takes the initial path for the first time period. The first condition may comprise a condition that the interference level is below an interference threshold value. Step 203 comprises an example implementation of step 103 of FIG. 1.

The second ML model may be deployed on the cloud. The second ML model may comprise a neural network, a random forest or a logistic regression, an Extreme Gradient (XG) boosting model, and a Long-Short term Memory (LSTM) model.

The second ML model may predict over each subframe in the next k subframes if the interference level is above an interference threshold value. It will be appreciated that the interference threshold may be a dynamic or a static threshold.

As previously described, the value of k may be chosen depending on the time required for the first wireless device to update its route and/or take additional RRM actions (as described later) to guarantee a maximum interference level it causes on the second radio network. It will be appreciated that there may be a tradeoff between prediction accuracy and proactive action decision in the selection of the value of k. For example, for a larger k, the prediction accuracy decreases but the first wireless device has more time to update its route and/or RRM actions.

The second ML model may be trained using supervised learning techniques. The output of the second ML model may be described as a binary classification problem over a set of future time stamps (t=0, t=1, t=1, . . . t=k).

The second ML model may receive one or more of the following features (Network features, Features relating to the second radio network, Features if the second radio network is a public/private cellular network, Features of the First Wireless) as inputs:

### Network Features

One or more historical values of the number of active and/or scheduled wireless devices for neighbouring network nodes belonging to the first radio network;
One or more historical values of the load on the neighbouring network nodes belonging to the first radio network;

One or more historical values of the utilized frequency domain resources at the neighbouring network nodes in the first radio network
A predicted load at neighbouring network nodes in the first radio network (which may be provided as an output of step 201).
One or more locations of the static network nodes belonging to the first radio network;
One or more locations of temporarily and/or permanent obstacles and/or devices within the geographical area;
One or more locations of the wireless devices connected to the neighbouring network nodes in the first radio network;
Information relating to beam directions for the neighbouring network nodes belonging to the first radio network;
information relating to a planned availability of the first spectrum band resources for a next k subframes (e.g., “spectrum access grants”)
Indication or feedback relating to a level or an impact of interference at the second radio network;
One or more historical values of the interference level.

### Optional Input—Features Relating to the Second Radio Network

locations of one or more static network nodes belonging to the second radio network;
Locations of the one or more wireless devices in the second radio network;
One or more historical values of utilized frequency domain resources at the second radio network;
Information relating to beam directions for the network nodes belonging to the second radio network.

### Optional Input—Features If the Second Radio Network Is a Public/Private Cellular Network

A predicted load at neighbouring network nodes belonging to the second radio network;
One or more historical values of the number of active and/or scheduled wireless devices for the network nodes belonging to the second radio network;
One or more historical values of the load on the network nodes belonging to the second radio network.

### Features of the First Wireless Device

A serving cell-id associated with the first network node;
One or more historical values of the load, traffic arrival rate, and/or packet size of the first wireless device;
One or more historical values of the allocated frequency domain resources for the first wireless device;
Information relating to the serving beam directions for the first wireless device;
A speed of the first wireless device;
An initial path of the first wireless device, e.g. a set of future locations (coordinates) of the first wireless device for the next k subframes;
One or more historical values for the service priority of the first wireless device;
One or more historical values for the locations of the first wireless device;
A location of X neighbouring wireless devices and their corresponding activity level/service characteristics (packet arrival rate, service priority, packet size).

In some examples, the second ML model receives one or more of the following as an input:
information relating to beam directions for a first network node serving the first wireless device and/or one or more neighbouring network nodes to the first network node in the first radio network;
information about planned availability of the first spectrum band at the second radio network for the first time period;
one or more historical values of a traffic load, traffic arrival rate, and/or a packet size experienced by the first wireless device;
one or more historical values of allocated frequency domain resources for the first wireless device; and
the initial path for the first time period.

The output of the second ML model is a vector of binary values that predicts whether or not the interference level that the communication between the first wireless device and the first radio network is causing on the second radio network is above an interference threshold value, over each of the next k subframes.

It will be appreciated that the interference threshold may be function of a minimum level of QoS required by the second radio network and the load level of the first radio network and may therefore be configured accordingly.

It will be appreciated that, in some scenarios, if other users are sharing the first spectrum band, there may be information about planned availability of the first spectrum band resources in addition to the corresponding QoS requirement or first condition for the next k subframes (e.g., “spectrum access grants” received from the neighboring network or from a spectrum sharing database).

This may then allow the first radio network to have an external indication that it could use certain frequency domain resources with some particular conditions (e.g. the first condition) for the coming time period.

It will therefore be appreciated that the first ML model and the second ML model may account for the dynamicity of the first condition and/or the QoS requirement. The first condition and the QoS requirement may be functions of the different network conditions.

To account for the dynamicity of the first condition and/or the QoS requirement, several classification models may be trained for the first ML model and/or the second ML model, each trained with a different first condition and/or QoS requirement, and all of the resulting models may be deployed on the cloud for real network operation.

It may be assumed that the actual QoS requirement and/or first condition may be an input to the first ML model or second ML model deployment agent which triggers the activation of the right prediction/classification model, during real time operation. (When herein referring to agent, what is considered is a software agent or software implemented agent.) Note that the first condition and/or QoS requirement may also be inputted by a network operator or an enterprise managing/operating the network.

In step 204 the method comprises determining whether (based on the output of the first ML model) the QoS requirement and (based on the output of the second ML model) the first condition are met.

If both the QoS requirement and the first condition are met, the method passes to step 205 in which the initial path of the first wireless device is not altered. The method then returns to step 201 and restarts after j subframes, where j<k.

If either the QoS requirement or the first condition are not met, the method passes to step 206.

Step 206 comprises an example implementation of step 104 of FIG. 1.

In step 206 a third ML model determines a new path for the first wireless device for the first time period. The third ML model may comprise a reinforcement learning model. In some examples, the third ML model determines a new path for the first wireless device and whether additional radio resource management, RRM, actions will be needed to guarantee that the QoS requirement will be met throughout the course of the new path, and that the interference level will continue to meet the first condition throughout the new path. The RRM actions may enable the new path to meet the QoS requirement and the first condition in case a path cannot be found (without the aid of RRM actions) for which the QoS requirement and the first condition can be met.

It will be appreciated that the new path determined by the third ML model may also be required to enable the first wireless device to reach a particular destination or perform a particular task, for example, within a particular time period.

The third ML model may be deployed in the cloud. The third ML model may be trained via reinforcement learning to learn the new path for the first wireless device:

It will be appreciated that a reinforcement learning model may be defined by a state, an action space and reward function.

Herein, the state may be considered to correspond to the input features that are important to represent the current environment for the learning process.

A state of the third ML model may comprise one or more:
The model of the geographical environment and the radio environment
one or more trajectories and/or locations in the geographical environment that cannot be traversed by the first wireless device, for example, no mobility zones or locations of permanent (e.g., industrial lines) and/or temporary obstacles;
One or more locations of other wireless devices and their corresponding paths (which are typically known to the network), loads for the next k subframes;
A speed of the first wireless device, and/or a maximum possible speed;
One or more historical values of the load on the first network node and/or one or more neighboring network nodes in the first radio network;
A predicted load at one or more neighbouring network nodes in the first radio network (which may be provided as an output of step 201)
A packet size transmitted to or received from the first radio network;
The QoS requirement of the first wireless device
One or more historical values of the load, traffic arrival rate, and/or packet size of the first wireless device;
One or more historical values of allocated frequency domain resources for the first wireless device;
Information relating to serving beam directions for the first wireless device;
One or more historical values for the service priority of the first wireless device;
One or more historical values of a number of active and/or scheduled wireless devices for neighboring cells belonging to the first radio network;
One or more historical values of utilized frequency domain resources at the neighboring cells belonging to the first radio network;
Locations of the static network nodes in the first radio network;
Locations of wireless devices connected to the neighboring network nodes in the first radio network;
Information relating to beam directions for the neighboring network nodes in the first radio network;
information relating to planned availability of the first spectrum band resources for the next k subframes (e.g., “spectrum access grants”);
An indication or feedback relating to the current interference level or the impact of the interference level at the second radio network;
One or more historical values of the interference level;
The QoS requirement and/or the first condition
A destination of the first wireless device or an action to accomplish, and any corresponding stop locations;
A maximum time allowed to accomplish the action;
A location of other wireless devices in the geographical area performing critical activities (and any corresponding critical QoS requirements);
A location of temporary and/or permanent obstacles or devices in the geographical area;
Optional State values:
   Location and traffic load of other wireless devices utilizing the first spectrum band (and their future set of coordinates) in the vicinity of the geographical area;
   Physical coordinates of network nodes of adjacent networks that are in the vicinity the geographical area;
   Locations of the wireless devices belonging to the second radio network that are in the vicinity of the geographical area;
   One or more historical values of utilized frequency domain resources at the second radio network;
   Information relating to beam directions for the network node belonging to the second radio network
   A predicted load at neighboring cells belonging to the second radio network;
   One or more historical values of a number of active and/or scheduled wireless devices for the network nodes belonging to the second radio network;
   One or more historical values of the load for the network nodes belonging to the second radio network.

An action space for the third ML model may comprise one or more of:
An array (e.g. two- or three-dimensional array) comprising coordinates of the first wireless device for the next k subframes; and
Potential RRM actions for the first wireless device to perform during the next k subframes.

In other words, for each subframe i in the next k subframes the action space of the third ML model may comprise possible coordinates in the array that the first wireless device can reach from its location at subframe i−1, and the potential RRM actions that could be performed at subframe i.

The reward for the third ML model may comprise a multi-objective reward function. The reward may be determined from one or more of: a QoS metric experienced by the first wireless device, a time period for the first wireless device to reach a destination, and the interference level.

It will be appreciated that the reward may be configured to reward movements of the first wireless device in which the QoS metric meets the QoS, requirement and the interference level meets the first condition.

In some examples, the third ML model determines the new path based on the reward such that, for the first time period:
a. the quality-of-service, QoS, requirement is met; and
b. the interference level meets the first condition.

It will be appreciated that in some examples, objectives of the reward may comprise one or more of:
Maximize the QoS experienced by the first wireless device, for example, to guarantee throughput, latency and reliability requirements;
Minimize a time period for the first wireless device to reach its destination or accomplish an action. In other words, it may not be desirable for the first wireless device to take a very long path that can delay work being accomplished;
Minimize the interference level. For instance, the new path may be selected to avoid congesting a path whereby critical industrial activities are happening where critical communication requirements are needed, and paths that result in high interference on another nearby network assumed to be sharing the spectrum.

In some examples, the third ML model may further determine one or more radio resource management, RRM, actions to be performed by the wireless device to ensure both a) and b). Alternatively, the RRM actions to be performed by the first wireless device may in some examples be learned separately via other processes (as suggested in PCT/SE2019/051124 and PCT/SE2021/050492).

Examples of such RRM actions, can be, but are not limited to:
Performing a handover of the first wireless device, for example, from the first network node to a more distant, but at the same time a less loaded network node. Alternatively, the first wireless device may be moved to a different and less loaded frequency (inter-frequency handover);
Coordinating the scheduling decisions between the first radio network and the second radio network, so that the interference between the networks can be mitigated;
Adjusting a link adaptation process for the first wireless device, for example, so that the first wireless device is assigned more robust modulation and coding schemes compared to a more capacity-optimized scenario;
In downlink, the first network node increases the transmission power towards the first wireless device. Similarly, for uplink, transmission power may be increased for the first wireless device by adjusting the uplink power control parameters;
In downlink, if the first network node is able to dynamically adjust the beamwidth of the serving beam, it makes the beam towards the first wireless device narrower, increasing the antenna directivity, and hence increasing the received signal power at first wireless device. Similarly, in the uplink direction, if the first wireless device is able to dynamically adjust the beamwidth of the transmit beam, it makes the beam towards the first network node narrower, increasing the antenna directivity, and hence increasing the received signal power at the first network node.

The use of additional RRM mechanisms may be beneficial in situations where a) alternative paths are not available, b) the alternative paths do not meet either the QoS requirement or the first condition, or c) the alternative paths are not able to satisfy the overall service requirements (e.g., with respect to the time it takes for the first wireless device to travel to its destination). In most of the cases, the proactive RRM mechanisms may need changes or new processes only at the network side (i.e., in the base stations or central control units), and they would utilize the already standardized signaling messages and functionalities specified for the air-interface and the user terminals. For some specific cases, for example related to beam management, there could possibly be a need to specify some new signaling messages to enable the network-assisted beamforming functionality implemented within the user terminals.

It will be appreciated that the third ML model may learn the optimal routes for multiple wireless devices simultaneously (for whom the future QoS cannot be met along their corresponding selected routes) or for each wireless device individually (which may lead to a multi-agent reinforcement learning problem).

However, in real-world applications, the scenario in which, during a subframe j, the QoS of several wireless devices are not met along their initial paths would not occur very often. For such scenarios, one would update the route of each wireless device separately during consecutive subframes i.e., at j, j+1, j+2.

As such, in some examples, the third ML model may be configured to optimize the path of each wireless devices individually, and therefore consecutively (as opposed to simultaneously), for a given network state, thus reducing the complexity for the third ML model and enabling a faster convergence of the third ML model.

The third ML model may be trained globally from data and interactions with the environment from all the network nodes within the geographical area.

In step 207, the third ML model indicates the new path (and any RRM actions determined in step 206) to the first wireless device. For example, the third ML model may transmit a message to the device, informing it about the new path and, if applicable, the RRM actions for the first wireless device to perform during the next k subframes.

In step 208 the first wireless device updates the initial path to the new path performs any indicated RRM actions.

It will be appreciated that steps 201 to 208 may be repeated every j subframes where j<k in order to guarantee that the first ML model and second ML model continuously monitor the QoS experienced by the first wireless device and the interference level caused on the second radio network, and therefore that the third ML model takes proactive actions by re-routing the first wireless device and/or taking additional RRM actions in case the QoS requirement and/or the first condition is no longer met.

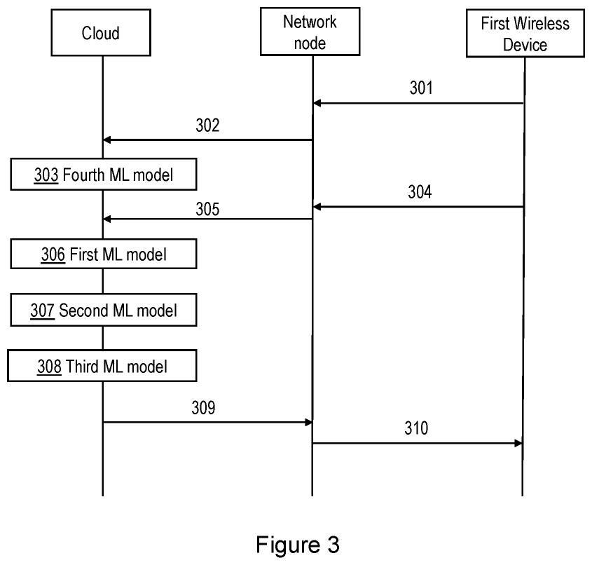

FIG. 3 illustrates a signalling diagram for an example implementation of the methods of FIGS. 1 and 2.

In step 301 a first wireless device transmits wireless device related features to the network node. These features may be one or more of the features available at the first wireless device that may be used as input features as described with reference to step 201 of FIG. 2.

In step 302, the network node forwards the wireless device related features and transmits any other features for input to the cloud. Step 302 comprises an example implementation of step 101 of FIG. 1.

In step 303 the fourth ML model predicts a load on a network node in the first radio network during the first time period. Step 303 comprises an example implementation of step 201 of FIG. 2. In this example, the fourth ML model is deployed in the cloud. It will however be appreciated that the fourth ML model may be deployed at each network node within the geographical area.

In step 304 the first wireless device transmits wireless device related features to the network node. These features may be one or more of the features available at the first wireless device that may be used as input features as described with reference to step 202 or 203 of FIG. 2.

In step 305 the network node forwards the wireless device related features and transmits any other features for input into the first ML model or the second ML model.

In step 306 the first ML model predicts whether a QoS, requirement for the first wireless device is met if the first wireless device takes an initial path through the geographical environment for a first time period. Step 306 comprises an example implementation of step 102 of FIGS. 1 and 202 of FIG. 2.

In step 307 the second ML model predicts whether an interference level meets a first condition if the first wireless device takes the initial path for the first time period, wherein the interference level is caused by communication between the first wireless device and the first radio network on the second radio network. Step 307 comprises an example implementation of step 103 of FIGS. 1 and 203 of FIG. 2.

In this example it is assumed that either or both of the first condition and the QoS requirement are not met.

In step 308 the third ML model determines a new path for the first wireless device for the first time period. Step 308 comprises an example implementation of step 206 of FIG. 2.

In step 309 the cloud transmits an indication of the new path and any RRM actions to be performed to the network node.

In step 310 the network node forwards the new path and the RRM actions to the first wireless device.

### Training Models

Note that for RL agents such as the third ML model, there are typically 2 phases of training: (i) exploitation and (ii) exploration, whereby a key concept is the tradeoff between exploration and exploitation.

Exploitation is defined as a greedy approach in which the RL agent tries to get more rewards by using estimated value. So, during this phase, agents make the best decision based on current information. Unlike exploitation, in exploration phase, the RL agent improves its knowledge about each action instead of getting more rewards so that it can get long-term benefits. So, during exploration, the RL agent gathers more information to make the best overall decision.

As such, to avoid any re-routing of the first wireless device (and additional RRM actions) that could possibly cause harmful effect of the network (during the exploration phase) one would typically assume that the third ML model is continuously trained off-line, and then the policy would be implemented live (and updated whenever an updated policy is trained).

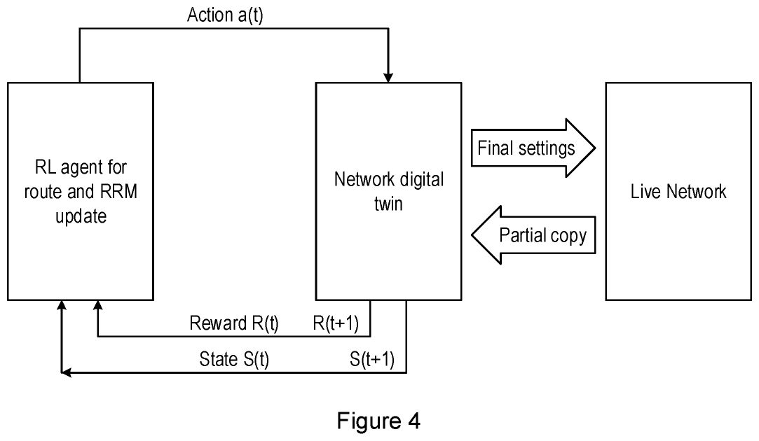

However, it is also possible that the outcome of the third ML model may cause harmful effects for some other reasons such as faulty behavior, the third ML model being compromised, or temporary changes in the network. As such, another possible solution would be to rely on the use of a full network digital twin such as that illustrated in FIG. 4 whereby the actions of the third ML model are first tested on the network digital twin and then transferred to real deployments if such actions show that they do not cause any extra harmful effect on the network (when tested on the network digital twin), for example, if the first condition and QoS requirement are met. The use of network digital twin here may be considered important for critical activities in industrial setups and, for example, to guarantee a service level agreement (SLA).

The outcome (i.e., reward value) of the actions on the network digital twin and real environment may then be compared to detect any possible drift in the policy of the real network, and if there is any drift model, re-training may be triggered.

### Re-Training of AI Models

To avoid model drift in real deployments, the first ML model, second ML model, third ML model and fourth ML model may need to be updated continuously.

The first ML model, second ML model and fourth ML model may be continuously re-trained on new datasets collected from real deployments. The re-training may happen either on-the-fly (and therefore avoid storing datasets) or in batches by storing a large new dataset and using this data for model re-training, for example, every K days.

For re-training the third ML model, one may need to explore new actions during different network states. To guarantee safe exploration in real deployments, the RL agent may update its model (i.e., learn the policy) on the digital twin (by exploring new possible actions) and then transfer this model/policy to real deployments therefore guaranteeing safe exploration (see FIG. 4).

The digital twin enables a safe simulated testing environment in which one can train and play out ‘what-if’ scenarios and train/update the third ML model, with no risk to the real-world counterpart. The parameters for the third ML model may then be transferred form the DT to the third ML model and hence the policy is implemented live (and is updated whenever an updated policy is re-trained).

To guarantee an environment in the digital twin that is equivalent to that of the real network, the contents of the digital twin are continuously updated and refined during operation based on the measurements received from both the network nodes and the wireless devices, as well as on measurements performed by additional sensors deployed around the system coverage area. In other words, data is transmitted back and forth to the DT in real-time.

The digital twin may comprise two types of information: static and dynamic. The static information includes for example a digital map of the area in question, information about the allowed paths (roads, corridors, obstacles (permanent and temporarily) etc), information (e.g., location, types and orientation of antennas) of the radio network nodes (base stations) in the first radio network, and information about the propagation conditions (or propagation losses) between the radio network nodes and the different positions along the allowed paths. The static information may also comprise details of the second radio network, e.g., locations of the static radio network nodes (base stations, fixed communication links, satellite gateway stations, fixed satellite terminals, radars), information about the types and orientations of the antennas and information about the propagation conditions between the radio network nodes of the first radio network and the radio network nodes of the second radio network.

The static information is expected to be fairly stable and does not need to be updated that often. In addition to the static information, the digital twin may comprise dynamic information about the current state of the radio network, including for example information about the locations of the wireless devices, the load on the network nodes and the user performance. The dynamic information may also include input from external sources, such as information received from the second radio network or spectrum sharing databases. The contents of the dynamic information may be updated much more often compared to the static information. Furthermore, the network should keep track of the history of the dynamic information to assist the AI/ML functionality.

### Example Implementation Scenario

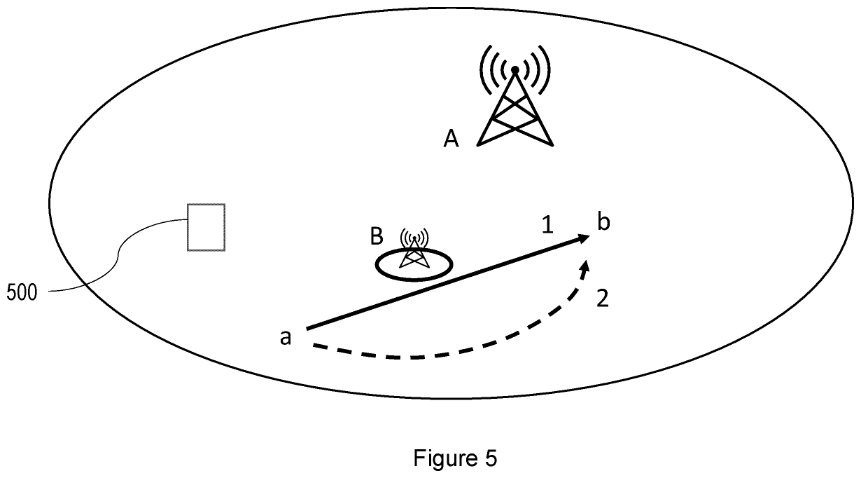

FIG. 5 illustrates an example scenario in which the methods of FIGS. 1 and 2 are implemented.

In particular, FIG. 5 illustrates a scenario in which a first wireless device 500 planned to move from point a to point b, while staying in the same first radio network, network A.

In this scenario, network A is assumed to be sharing the at least a first spectrum band with a second radio network, network B, which can be for example an incumbent user/network (having a primary right to use the first spectrum band) or a non-public network (having an exclusive right to use the first spectrum band within its premises or property and often entitled to a certain level of protection from other users of the first spectrum band).

It should be noted that in a typical scenario, the first wireless device going from point a to point b can only be connected to network/cell A and not network/cell B due to access restrictions and closed subscriber groups related to non-public networks or the different radio technologies utilized by the networks.

If network B is an incumbent user of the first spectrum band, it may not be active (i.e., using the first spectrum band) all the time, giving network A more freedom to reuse the first spectrum band during the off-periods. Similarly, the spectrum needs of a non-public network B may not be constant all the time but may vary.

To obtain a complete picture of the interference situation between the cells/networks, the interference mitigation procedure (i.e., the determination of the new path and any RRM actions) would have to consider different types of interference links:
interference between the first wireless device(s) connected to cell/network A and the (fixed and mobile stations of) victim cell/network B, and
interference between the base station(s) of cell/network A and the (fixed and mobile stations of) victim cell/network B.

If the victim cell/network B is a cellular network (e.g., a non-public network), the interference mitigation procedure may consider both the interference from network A to network B (“protect the other users of the first spectrum band”) as well as the interference from network B to network A (“guarantee the desired QoS for the first wireless device”). However, if the cell/network B is an incumbent user of the spectrum band, the interference mitigation procedure may focus only on the interference from network A to network B since the mitigation of such interference scenarios will typically also resolve the less frequent problems related to the interference from network B to network A.

Consider that network A learns/detects that the neighboring node/network B has become active and is: a) creating interference towards the first wireless device travelling along path 1, and/or b) requiring protection from the first wireless device travelling along path 1 or from the network node of network A serving the first wireless device travelling along path 1. To reduce the interference to or from network B, cell/network A determines the new path 2 from point a to point b.

In a later time step, if network B is no longer active, network A may re-design the route from point a to point b to follow path 1 again (since it's a faster or a shorter route). In general, network A may learn the activity of network B with the help of measurements, specific signaling between the networks, or some external database which could be controlling the use of the first spectrum band between the networks

In a special case, mobility between the cells/networks is allowed (e.g., both cells/networks belong to the same operator), but either one of the cells/networks A or B, or both of them, are applying flexible time division duplex (TDD) patterns or full duplex time division duplex (TDD) transmission. This results in a so-called cross-link TDD interference between the cells/networks, meaning that the downlink transmissions of base station(s) within network A are interfering the uplink reception of base station(s) within network B and vice versa. Similarly, the uplink transmissions of the first wireless device(s) connected to cell/network A are interfering the downlink reception of the wireless devices connected to cell/network B and vice versa. Also in this scenario, the interference between the cell/network A and cell/network B may be mitigated by re-designing the routes of the first wireless device connected to cell/network A.

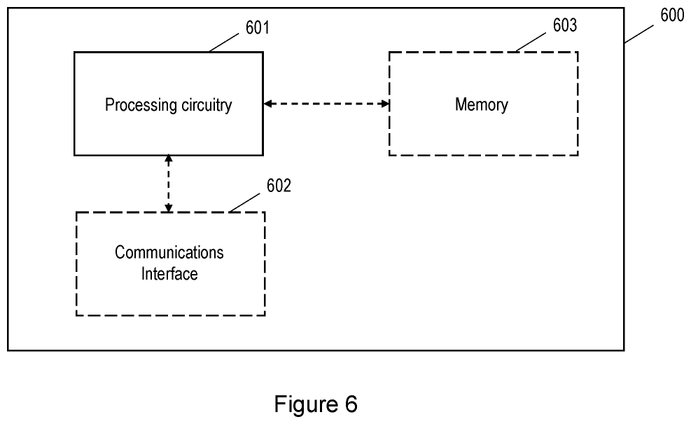

FIG. 6 illustrates an apparatus 600 comprising processing circuitry (or logic) 601. The processing circuitry 601 controls the operation of the apparatus 600 and can implement the method described herein in relation to an apparatus 600. The processing circuitry 601 can comprise one or more processors, processing units, multi-core processors or modules that are configured or programmed to control the apparatus 600 in the manner described herein. In particular implementations, the processing circuitry 601 can comprise a plurality of software and/or hardware modules that are each configured to perform, or are for performing, individual or multiple steps of the method described herein in relation to the apparatus 600. It will be appreciated that the apparatus 600 may comprise one or more virtual machines running different software and/or processes. The apparatus 600 may therefore comprise, or be implemented in or as one or more servers, switches and/or storage devices and/or may comprise cloud computing infrastructure that runs the software and/or processes.

Briefly, the processing circuitry 601 of the apparatus 600 is configured to obtain a model of a geographical environment and a radio environment through which the first wireless device is travelling, wherein the radio environment comprises a second radio network using at least the first spectrum band; predict whether a quality-of-service, QoS, requirement for the first wireless device is met if the first wireless device takes an initial path through the geographical environment for a first time period; predict whether an interference level meets a first condition if the first wireless device takes the initial path for the first time period, wherein the interference level is caused by communication between the first wireless device and the first radio network on the second radio network; and responsive to predicting that either the QoS requirement will not be met during the first time period, or the interference level will not meet the first condition during the first time period, initiate an update to the initial path to provide a new path to be taken by the first wireless device.

In some embodiments, the apparatus 600 may optionally comprise a communications interface 602. The communications interface 602 of the apparatus 600 can be for use in communicating with other nodes, such as other virtual nodes. For example, the communications interface 602 of the apparatus 600 can be configured to transmit to and/or receive from other nodes requests, resources, information, data, signals, or similar. The processing circuitry 601 of apparatus 600 may be configured to control the communications interface 602 of the apparatus 600 to transmit to and/or receive from other nodes requests, resources, information, data, signals, or similar. The communications interface 602 can use any suitable communication technology.

Optionally, the apparatus 600 may comprise a memory 603. In some embodiments, the memory 603 of the apparatus 600 can be configured to store program code that can be executed by the processing circuitry 601 of the apparatus 600 to perform the method described herein in relation to the apparatus 600. Alternatively or in addition, the memory 603 of the apparatus 600, can be configured to store any requests, resources, information, data, signals, or similar that are described herein. The processing circuitry 601 of the apparatus 600 may be configured to control the memory 603 of the apparatus 600 to store any requests, resources, information, data, signals, or similar that are described herein. The apparatus 600 may be configured operate in the manner described herein in respect of an apparatus.

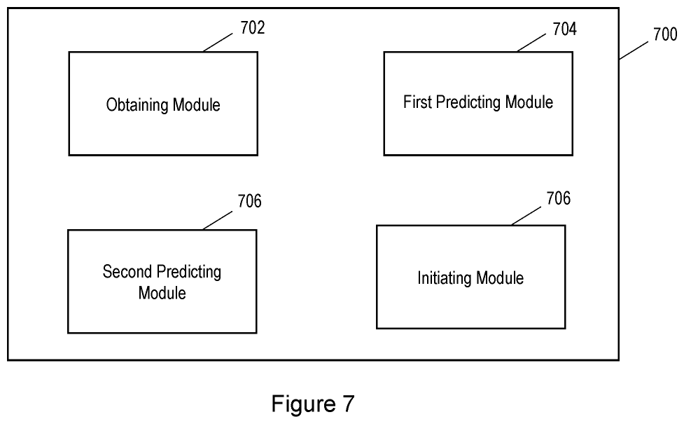

FIG. 7 is a block diagram illustrating an apparatus 700 according to some embodiments. The apparatus 700 can controlling a path taken by a first wireless device, wherein the first wireless device is in communication with a first radio network using at least a first spectrum band. The apparatus 700 comprises an obtaining module 702 configured to obtain a model of a geographical environment and a radio environment through which the first wireless device is travelling, wherein the radio environment comprises a second radio network using at least the first spectrum band. The apparatus 700 comprises a first predicting module 704 configured to predict whether a quality-of-service, QoS, requirement for the first wireless device is met if the first wireless device takes an initial path through the geographical environment for a first time period. The apparatus 700 further comprises a second predicting module 706 configured to predict whether an interference level meets a first condition if the first wireless device takes the initial path for the first time period, wherein the interference level is caused by communication between the first wireless device and the first radio network on the second radio network. The apparatus 700 further comprises an initiating module 708 configured to responsive to predicting that either the QoS requirement will not be met during the first time period, or the interference level will not meet the first condition during the first time period, initiate an update to the initial path to provide a new path to be taken by the first wireless device. The apparatus 700 may operate in the manner described herein in respect of an apparatus.

There is also provided a computer program comprising instructions which, when executed by processing circuitry (such as the processing circuitry 601 of the apparatus 600 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Embodiments described herein are able to provide a guaranteed quality of service for wireless devices whose path is being controlled by a first radio network. The methods and embodiments are adaptive to network dynamics and allow for online path re-planning.

The proactive path update may be able to guarantee QoS (latency and reliability) requirements and may protect victim networks or other users of the same spectrum band, for example incumbents or non-public networks.

The above sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s), and (where appropriate) state machines capable of performing such functions.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer implemented method for controlling a path taken by a first wireless device, wherein the first wireless device is in communication with a first radio network using at least a first spectrum band, the method comprising:
obtaining a model of a geographical environment and a radio environment through which the first wireless device is travelling, wherein the radio environment comprises a second radio network using at least the first spectrum band;
predicting whether a quality-of-service (QoS) requirement for the first wireless device is met if the first wireless device takes an initial path through the geographical environment for a first time period;
predicting whether an interference level meets a first condition if the first wireless device takes the initial path for the first time period, wherein the interference level is caused by communication between the first wireless device and the first radio network on the second radio network; and
responsive to predicting that either the QoS requirement will not be met during the first time period, or the interference level will not meet the first condition during the first time period, initiating an update to the initial path to provide a new path to be taken by the first wireless device.

2. The method of claim 1, wherein
the second radio network comprises: a cellular network, a satellite system, a fixed communication link, and/or a radar system.

3. The method of claim 1, wherein
the first time period comprises a next k subframes in the communication between the first wireless device and the first radio network.

4. The method of claim 1, wherein
the step of predicting whether a quality-of-service (QoS) requirement for the first wireless device is met if the first wireless device takes the initial path for the first time period comprises:
utilizing a first ML Model to predict whether the QoS requirements are met for the first time period.

5. The method of claim 4, wherein
the first ML model comprises one of: a neural network, a random forest, a logistic regression, a gradient boosting tree, and a Long Short-Term Memory (LSTM) model.

6. The method of claim 4, wherein
the first ML model receives as an input:
a historical interference level experienced by the first wireless device;
one or more historical values of traffic load on a network node serving the first wireless device and/or one or more neighboring network nodes in the first radio network;
one or more historical values of latency experienced by the first wireless device;
one or more historical values of a bit error rate or a block error rate experienced by the first wireless device;
one or more historical values of a packet arrival rate experienced by the first wireless device;
the QoS requirement; and/or
a predicted load at one or more neighboring network nodes to the network node serving the first wireless device.

7. The method of claim 4, wherein
the first time period comprises a next k subframes in the communication between the first wireless device and the first radio network, and
the first ML model predicts for each subframe in the next k subframes if the QoS requirement is met.

8. The method of claim 7, wherein
the QoS requirement comprises a requirement that a QoS metric experienced by the first wireless device meets a QoS threshold.

9. The method of claim 8, wherein
the QoS threshold comprises a dynamic threshold.

10. The method of claim 4, wherein
the first time period comprises a next k subframes in the communication between the first wireless device and the first radio network, and
the first ML model predicts for each subframe in the next k subframes values of one or more QoS metrics associated with the communication between the first wireless device and the first radio network.

11. The method of claim 1, wherein
the step of predicting whether an interference level caused by communication between the wireless device and the first radio network on the second radio network meets a first condition comprises:
utilizing a second ML model to predict whether the first condition is met.

12. The method of claim 11, wherein
the second ML model comprises one of: a neural network, a random forest or a logistic regression, Extreme Gradient (XG) boosting, and a Long-Short term Memory (LSTM) model.

13. The method of claim 11, wherein
the first time period comprises a next k subframes in the communication between the first wireless device and the first radio network, and
the second ML model predicts over each subframe in the next k subframes if the interference level is above an interference threshold value.

14. The method of claim 13, wherein
the interference threshold value comprises a dynamic threshold value.

15. The method of claim 11, wherein
the second ML model receives as an input:
information relating to beam directions for a network node serving the first wireless device and/or one or more neighboring network nodes to the network node in the first radio network;
information about planned availability of the first spectrum band at the second radio network for the first time period;
one or more historical values of a traffic load, traffic arrival rate, and/or a packet size experienced by the first wireless device;
one or more historical values of allocated frequency domain resources for the first wireless device; and/or
the initial path for the first time period.

16. The method of claim 1, wherein
the step of initiating an update to the path to be taken by the first wireless device comprises:
utilizing a third ML model to determine a new path for the first wireless device for the first time period.

17. The method of claim 16 wherein
the third ML model comprises a reinforcement learning model.

18. The method of claim 17, wherein
a state of the third ML model comprises:
one or more trajectories and/or locations in the geographical environment that cannot be traversed by the first wireless device;
one or more historical values of load for a network node serving the first wireless device and neighboring network nodes to the network node in the first radio network;
a predicted load at one or more neighboring network nodes in the first radio network;
information relating to beam directions for the neighboring network nodes in the first radio network;
information relating to planned availability of the first spectrum band for the first time period at the second radio network;
an indication of a current interference level;
one or more historical values of the interference level;
the QoS requirement and/or the first condition;
a destination or action to be completed by the first wireless device;
a maximum time allowed first the first wireless device to accomplish an action;
a location of other wireless devices in the geographical environment;
a location of temporarily and/or permanent obstacles or devices in the geographical environment; and/or
the model.

19. The method of claim 17, wherein
the first time period comprises a next k subframes in the communication between the first wireless device and the first radio network, and
an action space of the third ML model comprises one or more of: a two- or three-dimensional array comprising coordinates of the first wireless device for the next k subframes; and potential radio resource management, RRM, actions for the first wireless device to perform in the next k subframes.

20-29. (canceled)

30. An apparatus for controlling a path taken by a first wireless device, wherein the first wireless device is in communication with a first radio network using at least a first spectrum band, the apparatus comprising processing circuitry configured to cause the apparatus to:
obtain a model of a geographical environment and a radio environment through which the first wireless device is travelling, wherein the radio environment comprises a second radio network using at least the first spectrum band;
predict whether a quality-of-service (QoS) requirement for the first wireless device is met if the first wireless device takes an initial path through the geographical environment for a first time period;
predict whether an interference level meets a first condition if the first wireless device takes the initial path for the first time period, wherein the interference level is caused by communication between the first wireless device and the first radio network on the second radio network; and
responsive to predicting that either the QoS requirement will not be met during the first time period, or the interference level will not meet the first condition during the first time period, initiate an update to the initial path to provide a new path to be taken by the first wireless device.

31-34. (canceled)
